(19) United States
(12) Patent Application Publication
(10) Pub. No.: US 2011/0059372 A1
(43) Pub. Date: Mar. 10, 2011

(54) POSITIVE ELECTRODE FOR NONAQUEOUS ELECTROLYTE SECONDARY BATTERY AND NONAQUEOUS ELECTROLYTE SECONDARY BATTERY USING THE SAME

(75) Inventors: Takanobu Chiga, Kobe-city (JP); Naoki Imachi, Kobe-city (JP)

(73) Assignee: SANYO ELECTRIC CO., LTD., Moriguchi-city (JP)

(21) Appl. No.: 12/872,540

(22) Filed: Aug. 31, 2010

(30) Foreign Application Priority Data
Aug. 31, 2009 (JP) 2009-199881
Jul. 22, 2010 (JP) 2010-164720

(51) Int. Cl. H01M 10/056

(52) U.S. Cl. 429/346; 429/199; 429/207

(57) ABSTRACT

To provide a positive electrode for a nonaqueous electrolyte secondary battery having excellent flexibility and capable of increasing the reliability and productivity, and a nonaqueous electrolyte secondary battery using the positive electrode. The positive electrode for a nonaqueous electrolyte secondary battery includes an active material layer that contains: a positive-electrode active material; a binder made of a fluorine-contained resin containing a vinylidene fluoride unit; and an electrolyte represented by one of the following general formulae (1) and (2):

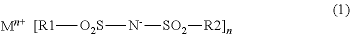

wherein M represents a metal element, R1 and R2 each represent fluorine or a fluorinated alkyl group having one to three carbon atoms and are identical to or different from each other, and n represents an integer of 1 to 3;

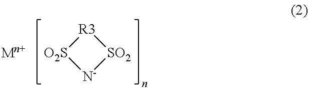

wherein M represents a metal element, R3 represents a fluorinated alkylene group having two to four carbon atoms, and n represents an integer of 1 to 3.

### BACKGROUND OF THE INVENTION

1. Field of the Invention

This invention relates to a positive electrode for a nonaqueous electrolyte secondary battery in which a fluorine-contained resin containing a vinylidene fluoride unit is used as a binder, a method for manufacturing the positive electrode, and a nonaqueous electrolyte secondary battery using the positive electrode.

2. Description of Related Arts

In recent years, size and weight reduction of mobile information terminals, such as cellular phones, notebook computers and PDAs, has rapidly progressed. Batteries used as their driving power sources are being required to achieve a higher capacity. Attention has been focused, as secondary batteries capable of meeting the above requirement, on lithium ion secondary batteries containing as a negative-electrode active material an alloy, a carbon material or the like capable of storage and release of lithium ions and containing as a positive-electrode active material a lithium-transition metal composite oxide, because of their high energy density.

A positive-electrode active material mainly used for existing lithium ion secondary batteries is lithium cobaltate (LiCoO₂) having a layered structure. However, cobalt is expensive. Furthermore, if the end-of-charge voltage is set at 4.3 V (vs. Li/Li⁺), the positive-electrode active material made of lithium cobaltate can utilize only a small capacity of about 160 mAh/g and therefore has the problem of low capacity. On the other hand, lithium-transition metal composite oxides containing nickel as a main transition metal and having a layered structure are also used as positive-electrode active materials. For example, LiNi_{0.80}Co_{0.15}Al_{0.05}O₂ exhibits a capacity of about 200 mAh/g. Such lithium-transition metal composite oxides have advantages of lower cost and higher capacity than those of lithium cobaltate.

Conventional attempts to increase the capacity of a lithium ion secondary battery have been made mainly by reducing the thicknesses of battery components not directly involved in capacity, such as a battery case, a separator or a current collector (made of aluminum or copper foil), or increasing the amount of active material packed (increasing the electrode packing density). However, if the electrode packing density is increased, then the electrode flexibility is reduced. Thus, even a slight stress applied to the electrode may cause a crack in the electrode, thereby lowering the battery productivity. Particularly, lithium-transition metal composite oxides containing nickel as a main transition metal and having a layered structure contain, as described in Published Japanese Patent Application No. 2006-185887, a larger amount of residual alkali salt than lithium cobaltate. This induces dehydrofluorination reaction of PVDF (poly(vinylidene fluoride)) serving as a binder and thereby gelates the binder. Therefore, the rolled positive electrode is very hard and has poor flexibility, which causes problems, such as breakage of the positive electrode when wound up, and in turn significantly lowers the battery productivity.

To solve the above problems, Published Japanese Patent Applications Nos. 2006-185887 and 2008-235157 propose to use two kinds of positive-electrode active materials having different average particle sizes.

However, if different active materials having different particle sizes are contained, their difference in reactivity prevents the occurrence of uniform charge/discharge reaction and may deteriorate cycle characteristics and the like.

In the present invention, as described later, a particular lithium salt is contained in an active material layer for a positive electrode. Published Japanese Patent Applications Nos. H05-62690, H08-335465 and 2008-21517 disclose that the addition of such a lithium salt to an electrolytic solution increases the shelf life or improves the cycle characteristics. However, these known techniques disclose neither that a lithium salt is added to an active material layer for a positive electrode nor that the addition of the lithium salt increases the flexibility of the positive electrode.

### SUMMARY OF THE INVENTION

An object of the present invention is to provide a positive electrode for a nonaqueous electrolyte secondary battery having excellent flexibility and capable of increasing the reliability and productivity, a method for manufacturing the positive electrode, and a nonaqueous electrolyte secondary battery using the positive electrode.

A positive electrode for a nonaqueous electrolyte secondary battery according to the present invention includes an active material layer that contains: a positive-electrode active material; a binder made of a fluorine-contained resin containing a vinylidene fluoride unit; and at least one of electrolytes represented by the following general formulae (1) and (2):

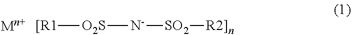

wherein M represents a metal element, R1 and R2 each represent fluorine or a fluorinated alkyl group having one to three carbon atoms and are identical to or different from each other, and n represents an integer of 1 to 3;

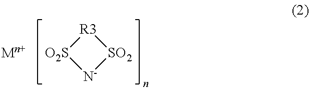

wherein M represents a metal element, R3 represents a fluorinated alkylene group having two to four carbon atoms, and n represents an integer of 1 to 3.

Examples of the metal element M in the general formulae (1) and (2) include Group IA elements in the Periodic Table, such as Li, Na and K, Group IIA elements, such as Mg, Ca and Sr, rare earth elements, such as Sc, Y and La, and Group IIIB elements, such as Al, Ga and In. Preferred among them are Group IA elements and Group IIA elements, and more preferred are Li, Mg and Na. Li is particularly preferable because it can contribute to charge/discharge reaction after dissolved in an electrolytic solution.

If the metal element M is lithium (Li), examples of the electrolyte used therewith include lithium salts represented by the following general formulae (3) and (4):

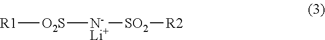

wherein R1 and R2 each represent fluorine or a fluorinated alkyl group having one to three carbon atoms and are identical to or different from each other;

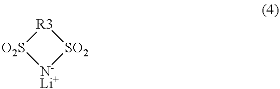

wherein R3 represents a fluorinated alkylene group having two to four carbon atoms.

Note that in the present invention, the “fluorinated” alkyl or alkylene group means an alkyl or alkylene group in which hydrogen atoms are at least partly fluorinated.

It can be assumed that if the above electrolyte is contained in the active material layer according to the present invention, this changes the precipitation form of the binder, in the drying step for forming the active material layer, to randomly distribute the binder, thereby giving flexibility to the positive electrode. More specifically, if a fluorine-contained resin containing a vinylidene fluoride unit is used as a binder, dehydrofluorination reaction is likely to occur in the step of drying the active material layer. If dehydrofluorination reaction occurs, the flexibility of the active material layer may be lost. Since in the present invention the above electrolyte is contained in the active material layer, this inhibits the occurrence of dehydrofluorination reaction, thereby giving flexibility to the positive-electrode active material layer.

Examples of the electrolyte represented by the general formula (3) include LiN(SO₂CF₃)₂, LiN(SO₂C₂F₅)₂, LiN(SO₂CF₃) (SO₂C₂F₅) and LiN(SO₂F)₂.

Examples of the electrolyte represented by the general formula (4) include lithium salts represented by the following chemical formulae (5) and (6):

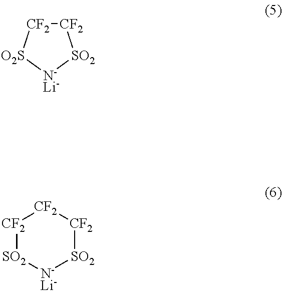

The most preferred electrolyte among the above is LiN(SO₂CF₃)₂ from a cost standpoint.

The binder used in the present invention is made of a fluorine-contained resin containing a vinylidene fluoride unit. Examples of such a binder include poly(vinylidene fluoride) (PVDF) and its copolymer.

In the present invention, the content of the electrolyte in the active material layer is preferably within the range of 0.01 to 5 parts by weight relative to 100 parts by weight of the positive-electrode active material, and more preferably within the range of 0.05 to 2 parts by weight. If the content of the electrolyte is below the above preferred range, the active material layer for the positive electrode may not be given a sufficient flexibility. On the other hand, if the content of the electrolyte is over the above range, the proportion of the positive-electrode active material contained in the active material layer is relatively reduced, which may reduce the battery capacity.

The positive-electrode active material to be used in the present invention is not particularly limited so long as it can store and release lithium and its electric potential is noble. For example, lithium-transition metal composite oxides having a layered structure, a spinel structure or an olivine structure can be used as positive-electrode active materials. Preferred among them are lithium-transition metal composite oxides having a layered structure from a high energy density standpoint.

Such lithium-transition metal composite oxides include lithium-nickel composite oxides, lithium-nickel-cobalt composite oxides, lithium-nickel-cobalt-aluminum composite oxides, lithium-nickel-cobalt-manganese composite oxides, and lithium-cobalt composite oxides.

Lithium-transition metal composite oxides particularly preferably used among them are, from a high capacity standpoint, those which contain lithium and nickel, in which the proportion of nickel in transition metals contained in the positive-electrode active material is 50% by mole or more and whose crystal structure comprises a layered structure.

From the standpoint of stability of the crystal structure, lithium-transition metal composite oxides containing lithium, nickel, cobalt and aluminum are more preferable.

If lithium cobaltate, which has been conventionally used, is used as a positive-electrode active material, lithium cobaltate containing aluminum (Al) or magnesium (Mg) in its crystal inside and having zirconium (Zr) adhered to the surfaces of particles thereof is preferably used from the standpoint of stability of the crystal structure.

The electrolyte used in the present invention is preferably used in a moisture-controlled environment because it is highly hygroscopic. The lithium-transition metal composite oxides containing nickel as a main transition metal and having a layered structure are also preferably used in a moisture-controlled environment because it tends to react with water. Thus, even if the electrolyte in the present invention is applied to the above lithium-transition metal composite oxide, a positive electrode can be manufactured without changing the production process. Hence, also from this standpoint, a lithium-transition metal composite oxide containing nickel as a main transition metal is preferably used as a positive-electrode active material layer.

In the present invention, the content of the binder is not particularly limited but is preferably within the range of 0.5 to 5 parts by weight relative to 100 parts by weight of the positive-electrode active material.

A nonaqueous electrolyte secondary battery according to the present invention includes: the above positive electrode for a nonaqueous electrolyte secondary battery according to the present invention; a negative electrode; and a nonaqueous electrolyte.

Since the nonaqueous electrolyte secondary battery according to the present invention uses the positive electrode for a nonaqueous electrolyte secondary battery according to the present invention, its positive electrode has excellent flexibility. Thus, in producing a nonaqueous electrolyte secondary battery, the occurrence of crack and shedding in the positive-electrode active material layer can be reduced. Hence, the reliability and productivity can be increased.

The negative-electrode active material for the negative electrode that can be used in the present invention is not particularly limited so long as it can store and release lithium. Examples of the negative-electrode active material include carbon materials, such as graphite and coke, metal oxides, such as tin oxide, metals capable of forming an alloy with lithium and storing lithium, such as silicon and tin, and metal lithium. Preferred among them are graphite and graphite-based carbon materials because they are less changed in volume by storage and release of lithium than others and have excellent reversibility.

The solvent to be used in the present invention is any solvent conventionally used for nonaqueous electrolyte secondary batteries. Particularly preferred among them are mixture solvents containing a cyclic carbonate and a chain carbonate. Specifically, the mixture ratio between cyclic carbonate and chain carbonate is preferably within the range of 1:9 to 5:5.

Examples of the cyclic carbonate include ethylene carbonate, fluoroethylene carbonate, propylene carbonate, butylene carbonate, vinylene carbonate and vinylethylene carbonate. Examples of the chain carbonate include dimethyl carbonate, ethyl methyl carbonate and diethyl carbonate.

Examples of the solute used in the present invention include LiPF₆, LiBF₄, LiCF₃SO₃, LiN(SO₂CF₃)₂, LiN(SO₂C₂F₅)₂, LiC(SO₂CF₃)₃, LiC(SO₂C₂F₅)₃, LiClO₄ and their mixtures.

A gelled polymer electrolyte in which a polymer, such as polyethylene oxide or polyacrylonitrile, is impregnated with an electrolytic solution can be used as a nonaqueous electrolyte.

### Effects of the Invention

According to the present invention, a positive electrode for a nonaqueous electrolyte secondary battery can be provided which has excellent flexibility and is capable of increasing the reliability and productivity. According to the manufacturing method of the present invention, a positive electrode having excellent flexibility can be manufactured and the reliability and productivity are increased.

Since the nonaqueous electrolyte secondary battery of the present invention uses a positive electrode having excellent flexibility, it can inhibit the occurrence of crack and shedding in the active material layer due to repeated charging and discharging, thereby providing good charge-discharge cycle characteristics.

### BRIEF DESCRIPTION OF DRAWINGS

FIG. 1 is a graph showing the relation between load on a positive electrode and displacement thereof when a pressing force is applied to the positive electrode for the evaluation of flexibility thereof in an example according to the present invention.

FIG. 2 is a schematic cross-sectional view for illustrating a test for evaluating the flexibility of the positive electrode in the example according to the present invention.

FIG. 3 is another schematic cross-sectional view for illustrating the test for evaluating the flexibility of the positive electrode in the example according to the present invention.

FIG. 4 is a scanning electron micrograph showing the surface of a coating produced in Experimental Example 1.

FIG. 5 is a scanning electron micrograph showing the surface of a coating produced in Experimental Example 2.

### DETAILED DESCRIPTION OF PREFERRED EXAMPLES

Hereinafter, the present invention will be further described with reference to specific examples. However, the present invention is not limited at all by the following examples, and can be embodied in various other forms appropriately modified without changing the spirit of the invention.

### Experiment 1

### Example 1

[Production of Positive Electrode]

LiNi_{0.80}Co_{0.15}Al_{0.05}O₂ (BET specific surface area: 0.27 m²/g, average particle size (D50): 15.2 μm) serving as a positive-electrode active material, acetylene black (AB) serving as an electronic conductor, and poly(vinylidene fluoride) (PVDF) serving as a binder were kneaded together with N-methyl-2-pyrrolidone (NMP) serving as a solvent. Thereafter further added to the resultant mixture was an NMP solution containing LiN(SO₂CF₃)₂ dissolved therein, followed by stirring, thereby preparing a positive electrode slurry. The contents of positive-electrode active material, electronic conductor, binder and electrolyte in the positive electrode slurry were controlled to give a weight ratio of 94:2.5:2.5:1. The electrolyte contained was 1.1 parts by weight relative to 100 parts by weight of positive-electrode active material.

The prepared slurry was applied to both the surfaces of a piece of aluminum foil, dried and then rolled, thereby obtaining a positive electrode. The packing density of the positive electrode was 3.3 g/cm³.

[Evaluation of Positive Electrode Flexibility]

The positive electrode obtained in the above manner was evaluated for flexibility in the following manner.

The positive electrode was cut out into a piece 50 mm wide and 20 mm long. As shown in FIG. 2, both ends of the cut positive electrode piece 1 was attached to both ends of a 30 mm wide acrylic plate 2 with double-faced tape.

Next, using a pressure tester (“FGS-TV” and “FGP-0.5” manufactured by NIDEC-SHIMPO CORPORATION), a pressing force was applied to a central region la of the positive electrode piece 1 through a pressing part 3 of the tester. The pressing speed was a constant rate of 20 mm per minute.

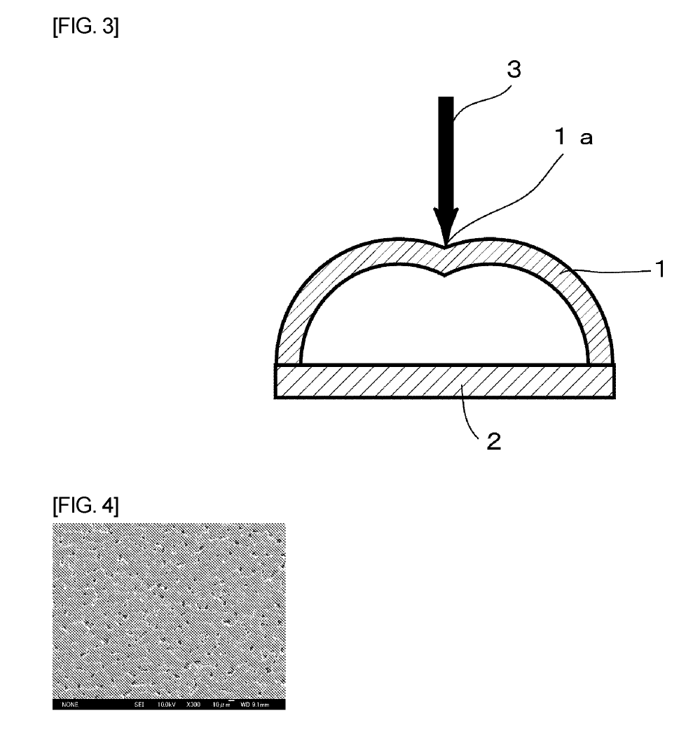

FIG. 3 is a schematic cross-sectional view showing a state of the positive electrode piece 1 in which a downward bend was produced in the central region 1a of the piece 1 by the application of the pressing force. A load applied to the piece 1 just before the above downward bend was produced was defined as the maximum load value.

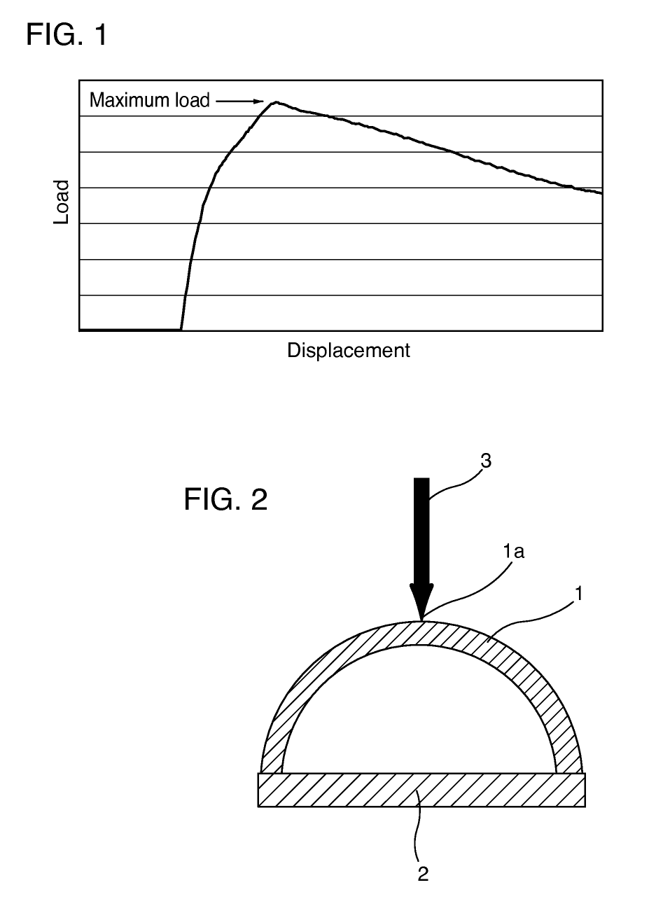

FIG. 1 is a graph showing the relation between load applied to the positive electrode piece and displacement of the piece. As shown in FIG. 1, the maximum load value was determined as a maximum load. The determined maximum load at the positive electrode piece was defined as flexibility of the positive electrode and is shown in TABLE 1.

[Preparation of Nonaqueous Electrolytic Solution]

Ethylene carbonate (EC) and diethyl carbonate (DEC) were mixed to give a volume ratio of 3:7. Added to the resultant mixture solvent was LiPF₆ to reach a concentration of 1 mol/L, thereby preparing a nonaqueous electrolytic solution.

[Production of Three-Electrode Test Cell]

A strip cut from the above positive electrode was used as a working electrode, and two strips cut from a rolled lithium sheet having a predetermined thickness were used as a counter electrode and a reference electrode.

In a glove box under an inert gas atmosphere, the cut positive electrode strip and the lithium counter electrode were wound up to be opposed to each other with a polyethylene separator interposed therebetween, thereby producing a roll. The resultant roll and the reference electrode were encapsulated in a laminate outer package. Then, the above-mentioned nonaqueous electrolytic solution was poured into the outer package and sealed, thereby producing a three-electrode test cell.

[Evaluation of Initial Charge/Discharge Characteristics]

The test cell was charged at 0.75 mA/cm² to 4.3 V versus the reference electrode and then charged again at 0.25 mA/cm² to 4.3 V, and the initial charge capacity was then measured. Thereafter, the test cell was discharged at 0.75 mA/cm² to 2.75 V, and the initial discharge capacity was then measured. An initial charge/discharge efficiency was calculated from the measured initial charge capacity and initial discharge capacity according to the following equation.

Initial charge/discharge efficiency (%)={(initial discharge capacity)/(initial charge capacity)}×100

[Evaluation of Cycle Characteristics]

The test cell was repeatedly charged and discharged under the same conditions as for the evaluation of the initial charge/discharge characteristics, and the discharge capacity after 20 cycles of charging and discharging was measured. Then, the capacity retention was calculated according to the following equation.

Capacity retention (%)={(20th cycle discharge capacity)/(initial discharge capacity)}×100

The measured initial charge capacity, measured initial discharge capacity, calculated initial charge/discharge efficiency, measured 20th cycle discharge capacity and calculated capacity retention are shown in TABLE 2.

### Example 2

In the same manner as in Example 1 except that LiN(SO₂C₂F₅)₂ was used as an electrolyte, a positive electrode was produced and a test cell was then produced using the obtained positive electrode. The positive electrode and test cell were evaluated in the same manner as in Example 1, and the evaluation results are shown in TABLES 1 and 2.

### Example 3

In the same manner as in Example 1 except that a lithium salt represented by the formula (5) described above was used as an electrolyte, a positive electrode was produced and a test cell was then produced using the obtained positive electrode. The positive electrode and test cell were evaluated in the same manner as in Example 1, and the evaluation results are shown in TABLES 1 and 2.

### Comparative Example 1

A positive electrode and a test cell were produced in the same manner as in Example 1 except that no electrolyte was added to the positive electrode slurry and the weight ratio among the positive-electrode active material, the electronic conductor and the binder was controlled to be 95:2.5:2.5. The obtained positive electrode and test cell were evaluated in the same manner as in Example 1, and the evaluation results are shown in TABLES 1 and 2.

### Comparative Example 2

In the same manner as in Example 1 except that LiBF₄ was used as an electrolyte, a positive electrode was produced and a test cell was then produced using the obtained positive electrode. The positive electrode and test cell were evaluated in the same manner as in Example 1, and the evaluation results are shown in TABLES 1 and 2.

### Comparative Example 3

A positive electrode slurry was prepared in the same manner as in Example 1 except that LiPF₆ was used as an electrolyte. However, the obtained slurry could not be uniformly applied on a piece of aluminum foil. It can be assumed that the reason for this is that LiPF₆ caused hydrolysis. Therefore, evaluation was not made of the positive electrode and test cell in this comparative example.

TABLE 1

| | Positive-Electrode | Electrolyte Added to | Maximum |
|---|---|---|---|
| | Active Material | Positive Electrode | Load (mN) |
| Example 1 | LiNi_{0.80}Co_{0.15}Al_{0.05}O₂ | LiN(SO₂CF₃)₂ | 150 |
| Example 2 | LiNi_{0.80}Co_{0.15}Al_{0.05}O₂ | LiN(SO₂C₂F₅)₂ | 155 |
| Example 3 | LiNi_{0.80}Co_{0.15}Al_{0.05}O₂ | Formula (5) | 148 |
| Comparative | LiNi_{0.80}Co_{0.15}Al_{0.05}O₂ | Nothing Added | 332 |
| Example 1 | | | |
| Comparative | LiNi_{0.80}Co_{0.15}Al_{0.05}O₂ | LiBF₄ | 349 |
| Example 2 | | | |
| Comparative | LiNi_{0.80}Co_{0.15}Al_{0.05}O₂ | LiPF₆ | X |
| Example 3 | | | |

TABLE 1 shows that the positive electrodes produced in Examples 1 to 3 according to the present invention have small maximum loads and therefore excellent flexibility. TABLE 1 also shows that in contrast, the positive electrode of Comparative Example 1 containing no electrolyte added and the positive electrode of Comparative Example 2 containing LiBF₄ added as an electrolyte have large maximum loads and therefore poor flexibility.

In Comparative Example 3 in which LiPF₆ was added to the slurry, no positive electrode could be produced as described above.

TABLE 2

| | | Electrolyte | Initial Charge | Initial Discharge | Initial Charge/ | 20th Cycle Discharge | Capacity |
|---|---|---|---|---|---|---|---|
| | Positive-Electrode | Added to | Capacity | Capacity | Discharge | Capacity | Retention |
| | Active Material | Positive Electrode | (mAh/g) | (mAh/g) | Efficiency (%) | (mAh/g) | (%) |
| Example 1 | LiNi_{0.80}Co_{0.15}Al_{0.05}O₂ | LiN (SO₂CF₃)2 | 215.9 | 188.1 | 87.1 | 101.8 | 54% |
| Example 2 | LiNi_{0.80}Co_{0.15}Al_{0.05}O₂ | LiN (SO₂C₂F₅)₂ | 216.3 | 188.4 | 87.1 | 111.4 | 59% |
| Example 3 | LiNi_{0.80}Co_{0.15}Al_{0.05}O₂ | Formula (5) | 215.5 | 187.6 | 87 | 112.7 | 60% |
| Comparative | LiNi_{0.80}Co_{0.15}Al_{0.05}O₂ | Nothing Added | 217.7 | 190.4 | 87.4 | 84 | 44% |
| Example 1 | | | | | | | |
| Comparative | LiNi_{0.80}Co_{0.15}Al_{0.05}O₂ | LiBF₄ | 209.5 | 180.1 | 86 | 83.9 | 47% |
| Example 2 | | | | | | | |

As is evident from the results shown in TABLE 2, the cells of Examples 1 to 3 according to the present invention exhibit comparable initial charge capacities, initial discharge capacities and initial charge/discharge efficiencies to those of the cell of Comparative Example 1 containing no electrolyte added and the cell of Comparative Example 2 containing LiBF₄ added as an electrolyte.

Furthermore, the cells of Examples 1 to 3 according to the present invention have higher 20th cycle discharge capacities and better capacity retentions than the cells of Comparative Examples 1 and 2. It can be assumed that the reason for this is that the flexibility of the positive electrode was increased, and the stress due to volume change of the positive-electrode active material during charging and discharging was therefore reduced, whereby the cycle characteristics were improved. It can be assumed that the reason is that particularly the charge/discharge reaction in the innermost region of the roll was made uniform and the cycle characteristics were therefore improved.

### Experiment 2

### Example 4

A positive electrode was produced and evaluated for flexibility in the same manner as in Example 1 except that instead of LiNi_{0.80}Co_{0.15}Al_{0.05}O₂, LiCoO₂ was used as a positive-electrode active material which contained 1% by mole of Al and 1% by mole of Mg in its crystal inside and had 0.05% by mole of Zr adhered to the surface thereof, and the packing density of the positive electrode was 3.6 g/cm². The evaluation results are shown in TABLE 3.

### Example 5

A positive electrode was produced and evaluated for flexibility in the same manner as in Example 4 except that an electrolyte represented by the formula (5) was used as a lithium salt. The results are shown in TABLE 3.

### Comparative Example 4

A positive electrode was produced and evaluated for flexibility in the same manner as in Example 4 except that no electrolyte was added to the slurry for producing a positive electrode. The results are shown in TABLE 3.

TABLE 3

| | Positive-Electrode | Electrolyte Added to | Maximum Load |
|---|---|---|---|
| | Active Material | Positive Electrode | (mN) |
| Example 4 | LiCoO₂ | LiN(SO₂CF₃)₂ | 91 |
| Example 5 | LiCoO₂ | Formula (5) | 85 |
| Comparative | LiCoO₂ | Nothing Added | 270 |
| Example 4 | | | |

As is evident from the results shown in TABLE 3, it has been confirmed that also in the case of using LiCoO₂ as a positive-electrode active material, the positive electrode exhibits high flexibility.

### Experiment 3

### Example 6

LiCoO₂ serving as a positive-electrode active material (which contained 1.0% by mole of Al and 1.0% by mole of Mg in its crystal inside and had 0.05% by mole of Zr adhered to the surface thereof), acetylene black (AB) serving as an electronic conductor, and poly(vinylidene fluoride) (PVDF) serving as a binder were kneaded together with N-methyl-2-pyrrolidone (NMP) serving as a solvent. Thereafter further added to the resultant mixture was an NMP solution containing LiN(SO₂CF₃)₂ dissolved therein, followed by stirring, thereby preparing a positive electrode slurry.

The contents of LiCoO₂, acetylene black, poly(vinylidene fluoride) and electrolyte in the positive electrode slurry were controlled to give a weight ratio of 94:2.5:2.5:1. In this case, LiN(SO₂CF₃)₂ contained was 1.1% by weight relative to the positive-electrode active material. The prepared slurry was applied to both the surfaces of a piece of aluminum foil, dried and then rolled, thereby obtaining a positive electrode. The packing density of the positive electrode was 3.8 g/cm³.

The flexibility of the positive electrode was evaluated in the same manner as in Example 1.

[Production of Negative Electrode]

Graphite serving as a negative-electrode active material, styrene-butadiene rubber serving as a binder, and a sodium salt of carboxymethyl cellulose serving as a thickener were mixed to give a weight ratio of 98:1:1 and kneaded in an aqueous solution, thereby preparing a negative electrode mixture slurry. The negative electrode mixture slurry was applied on both surfaces of a negative electrode current collector made of copper foil, dried and rolled, thereby producing a negative electrode.

[Preparation of Nonaqueous Electrolytic Solution]

Ethylene carbonate (EC) and diethyl carbonate (DEC) were mixed and controlled to be an EC to DEC volume ratio of 3:7. Added to the resultant mixture solution was LiPF₆ to reach a concentration of 1.0 mol/L, thereby preparing a nonaqueous electrolytic solution.

[Assembly of Battery]

Lead terminals were attached to the above positive and negative electrodes, a separator was interposed between the positive and negative electrodes, and these components were wound up together and pressed down in a flattened form, thereby producing an electrode assembly. The electrode assembly was inserted into an aluminum laminate serving as a battery outer package, and the above nonaqueous electrolytic solution was poured into the aluminum laminate, thereby producing a test battery. Note that the battery was designed to have an end-of-charge voltage of 4.4 V and the design capacity of the battery was 750 mAh.

[Evaluation of Battery Capacity]

The battery was charged to a battery voltage of 4.4 V at a constant current of 1 It (750 mA) and then charged to a current of 1/20 It (37.5 mA) at a constant voltage of 4.4 V. Next, the battery was discharged to a battery voltage of 2.75 V at a constant current of 1 It (750 mA), and the initial discharge capacity of the battery was then measured.

### Example 7

In the same manner as in Example 6 except that the weight ratio among LiCoO₂, AB, PVDF and LiN(SO₂CF₃)₂ in the positive electrode slurry was controlled to be 94.5:2.5:2.5:0.5, a positive electrode was produced and the flexibility of the positive electrode and the battery capacity were evaluated. In this case, LiN(SO₂CF₃)₂ contained was 0.5% by weight relative to the positive-electrode active material.

### Example 8

In the same manner as in Example 6 except that the weight ratio among LiCoO₂, AB, PVDF and LiN(SO₂CF₃)₂ in the positive electrode slurry was controlled to be 94.9:2.5:2.5:0.1, a positive electrode was produced and the flexibility of the positive electrode and the battery capacity were evaluated. In this case, LiN(SO₂CF₃)₂ contained was 0.1% by weight relative to the positive-electrode active material.

### Example 9

In the same manner as in Example 8 except that an electrolyte represented by the formula (5) was used instead of LiN(SO₂CF₃)₂, a positive electrode was produced and the flexibility of the positive electrode and the battery capacity were evaluated.

### Example 10

In the same manner as in Example 8 except that LiN(SO₂F)₂ was used instead of LiN(SO₂CF₃)₂, a positive electrode was produced and the flexibility of the positive electrode and the battery capacity were evaluated.

### Example 11

In the same manner as in Example 8 except that LiN(SO₂C₂F₅)₂ was used instead of LiN(SO₂CF₃)₂, a positive electrode was produced and the flexibility of the positive electrode and the battery capacity were evaluated.

### Example 12

In the same manner as in Example 8 except that Mg[N(SO₂CF₃)₂]₂ was used instead of LiN(SO₂CF₃)₂, a positive electrode was produced and the flexibility of the positive electrode and the battery capacity were evaluated.

### Comparative Example 5

A positive electrode was produced in the same manner as in Example 6 except that no LiN(SO₂CF₃)₂ was added to the positive electrode slurry and the weight ratio among LiCoO₂ (which contained 1.0% by mole of Al and 1.0% by mole of Mg in its crystal inside and had 0.05% by mole of Zr adhered to the surface thereof), AB and PVDF in the positive electrode slurry was controlled to be 95:2.5:2.5. The flexibility of the positive electrode and the battery capacity were evaluated in the same manner as in Example 6.

### Comparative Example 6

A battery was produced and evaluated for battery capacity in the same manner as in Comparative Example 5 except that a mixture solvent of ethylene carbonate (EC) and diethyl carbonate (DEC) was prepared to give a volume ratio of 3:7 and an electrolytic solution prepared by adding to the mixture solvent 1.0 mol/L of LiPF₆ and 0.08 mol/L of LiN(SO₂CF₃)₂ was used.

[Evaluation of Positive Electrode Flexibility]

TABLE 4

| | Electrolyte Added to | Amount Added | Maximum Load |
|---|---|---|---|
| | Positive Electrode | (% by weight) | (mN) |
| Example 6 | LiN(SO₂CF₃)₂ | 1.1 | 100 |
| Example 7 | LiN(SO₂CF₃)₂ | 0.5 | 118 |
| Example 8 | LiN(SO₂CF₃)₂ | 0.1 | 165 |
| Example 9 | Formula (5) | 0.1 | 169 |
| Example 10 | LiN(SO₂F)₂ | 0.1 | 186 |
| Example 11 | LiN(SO₂C₂F₅)₂ | 0.1 | 159 |
| Example 12 | Mg[N(SO₂CF₃)₂]₂ | 0.1 | 154 |
| Comparative | Nothing | 0 | 247 |
| Example 5 | | | |

It has been confirmed from the data on Examples 6, 7 and 8 shown in TABLE 4 that the flexibility is increased with increasing amount of LiN(SO₂CF₃)₂ added.

It has been also confirmed that also if an electrolyte represented by the formula (5), LiN(SO₂F)₂, LiN(SO₂C₂F₅)₂ or Mg[N(SO₂CF₃)₂]₂ is added instead of LiN(SO₂CF₃)₂, the flexibility is increased. It can be assumed that the reason for this is that the addition of an electrolyte having a high dissociability causes interaction of cations with PVDF in the positive electrode slurry and PVDF is finely precipitated in the drying step, whereby the electrode plate is given flexibility.

[Evaluation Results of Battery Capacities]

TABLE 5

| | | | | Discharge |
|---|---|---|---|---|
| | Site of Addition | Electrolyte Added | Amount Added | Capacity (mAh) |
| Example 6 | Positive electrode | LiN(SO₂CF₃)₂ | 1.1% by weight | 747 |
| Example 7 | Positive electrode | LiN(SO₂CF₃)₂ | 0.5% by weight | 756 |
| Example 8 | Positive electrode | LiN(SO₂CF₃)₂ | 0.1% by weight | 748 |
| Example 9 | Positive electrode | Formula (5) | 0.1% by weight | 755 |
| Example 10 | Positive electrode | LiN(SO₂F)₂ | 0.1% by weight | 749 |
| Example 11 | Positive electrode | LiN(SO₂C₂F₅)₂ | 0.1% by weight | 752 |
| Example 12 | Positive electrode | Mg[N(SO₂CF₃)₂]₂ | 0.1% by weight | 750 |
| Comparative | — | Nothing | 0% by weight | 755 |
| Example 5 | | | | |
| Comparative | Electrolytic | LiN(SO₂CF₃)₂ | 0.08 mol/L | 755 |
| Example 6 | solution | | | |

As shown in TABLE 5, it has been confirmed that all the batteries are substantially comparable in battery capacity.

[Evaluation of Discharge Load Characteristic]

Each of the batteries of Examples 6, 7 and 8 and Comparative Examples 5 and 6 was evaluated for discharge load characteristic in the following manner.

The battery was charged to a battery voltage of 4.4 V at a constant current of 1 It (750 mA) and then charged to a current of 1/20 It (37.5 mA) at a constant voltage of 4.4 V. Next, the battery was discharged to a battery voltage of 2.75 V at a constant current of 1 It (750 mA), and the discharge capacity of the battery at 1 It was then measured.

After charged again under the same conditions described above, the battery was discharged to a battery voltage of 2.75 V at a constant current of 3 It (2250 mA), and the discharge capacity of the battery at 3 It was then measured. The rate of the discharge capacity at 3 It to the discharge capacity at 1 It was calculated as a 3-It load rate (%). The results are shown in TABLE 6.

[Evaluation Results of Discharge Load Characteristic]

TABLE 6

| | | | 3-It Load Rate |
|---|---|---|---|
| | Site of Addition | Amount Added | (%) |
| Example 6 | Positive electrode | 1.1% by weight | 91 |
| Example 7 | Positive electrode | 0.5% by weight | 90 |
| Example 8 | Positive electrode | 0.1% by weight | 88 |
| Comparative | Nothing | 0% by weight | 84 |
| Example 5 | | | |
| Comparative | Electrolytic solution | 0.08 mol/L | 85 |
| Example 6 | | | |

As shown in TABLE 6, it has been confirmed that the load rate is increased with increasing amount of LiN(SO₂CF₃)₂ added to the positive electrode. Furthermore, the concentration of electrolyte in the electrolytic solution in Example 6 after LiN(SO₂CF₃)₂ in the positive electrode is dissolved in the electrolytic solution is comparable to that in the electrolytic solution used in Comparative Example 6, but the load rate of the battery of Comparative Example 6 is below those of the batteries of Examples 6, 7 and 8. In other words, it can be assumed that the increase in discharge load characteristic in Examples is due to the electrolyte being contained in the electrode and not due simply to the increase in concentration of electrolyte in the electrolytic solution.

As seen from the above, if such an electrolyte as described above is contained in the positive electrode, the electrode plate is given flexibility, which provides increased battery productivity and increased load characteristic.

### Reference Experiment

### Experimental Example 1

An NMP solution containing PVDF dissolved therein and an NMP solution containing LiN(SO₂CF₃)₂ dissolved therein were mixed and stirred. The weight ratio of PVDF to LiN(SO₂CF₃)₂ in this solution was controlled to be 100:20. The prepared solution was applied to a surface of a piece of aluminum foil and then dried at 120° C. The surface of the resultant coating was observed with a scanning electron microscope (SEM).

FIG. 4 is a scanning electron micrograph showing the surface of the coating of Experimental Example 1.

### Experimental Example 2

A coating was produced in the same manner as in Experimental Example 1 except that no LiN(SO₂CF₃)₂ was added, and the surface of the produced coating was observed with a SEM.

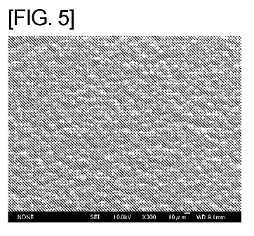

FIG. 5 is a scanning electron micrograph showing the surface of the coating produced in Experimental Example 2.

A comparison between FIGS. 4 and 5 reveals that in Experimental Example 2 in which the coating was made only of PVDF, PVDF formed a dense film. In contrast, in Experimental Example 1 in which LiN(SO₂CF₃)₂ was added, a high-voidage layer was produced. It can be assumed that the reason for this is that since dissociated Li⁺ ions interact with PVDF to change the precipitation form of PVDF so that PVDF is finely precipitated, whereby a high-voidage layer is produced to give flexibility to the electrode plate.

What is claimed is:

1. A positive electrode for a nonaqueous electrolyte secondary battery, the positive electrode comprising an active material layer that contains: a positive-electrode active material; a binder made of a fluorine-contained resin containing a vinylidene fluoride unit; and at least one of electrolytes represented by the following general formulae (1) and (2): 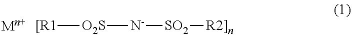
wherein M represents a metal element, R1 and R2 each represent fluorine or a fluorinated alkyl group having one to three carbon atoms and are identical to or different from each other, and n represents an integer of 1 to 3; 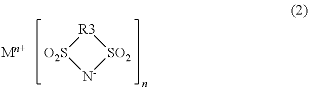
wherein M represents a metal element, R3 represents a fluorinated alkylene group having two to four carbon atoms, and n represents an integer of 1 to 3.

2. The positive electrode for a nonaqueous electrolyte secondary battery according to claim 1, wherein the electrolyte is at least one of lithium salts represented by the following general formulae (3) and (4): 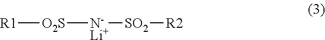
wherein R1 and R2 each represent fluorine or a fluorinated alkyl group having one to three carbon atoms and are identical to or different from each other; 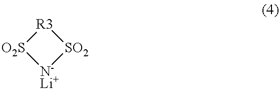
wherein R3 represents a fluorinated alkylene group having two to four carbon atoms.

3. The positive electrode for a nonaqueous electrolyte secondary battery according to claim 1, wherein the binder is poly(vinylidene fluoride).

4. The positive electrode for a nonaqueous electrolyte secondary battery according to claim 1, wherein the positive-electrode active material is a lithium-transition metal composite oxide which contains lithium and nickel, in which the proportion of nickel in transition metals contained in the positive-electrode active material is 50% by mole or more and which has a layered structure.

5. The positive electrode for a nonaqueous electrolyte secondary battery according to claim 4, wherein the lithium-transition metal composite oxide contains lithium, nickel, cobalt and aluminum.

6. The positive electrode for a nonaqueous electrolyte secondary battery according to claim 1, wherein the positive-electrode active material is lithium cobaltate containing aluminum or magnesium in its crystal inside and having zirconium adhered to the surfaces of particles thereof.

7. The positive electrode for a nonaqueous electrolyte secondary battery according to claim 1, wherein the electrolyte is LiN(SO₂CF₃)₂.

8. The positive electrode for a nonaqueous electrolyte secondary battery according to claim 1, wherein the electrolyte is contained by 0.01 to 5 parts by weight relative to 100 parts by weight of the positive-electrode active material.

9. A nonaqueous electrolyte secondary battery comprising: the positive electrode according to claim 1; a negative electrode; and a nonaqueous electrolyte.
